(19) United States
(12) Patent Application Publication
(10) Pub. No.: US 2022/0000229 A1
(43) Pub. Date: Jan. 6, 2022

(54) APPARATUS AND METHOD FOR WIRELESS EARPIECE HOLDER WITH ONE-HANDED OPERATION

(71) Applicant: NOAH SAPIR, Albuquerque, NM (US)

(72) Inventor: NOAH SAPIR, Albuquerque, NM (US)

(21) Appl. No.: 17/177,176

(22) Filed: Feb. 16, 2021

Related U.S. Application Data
(60) Provisional application No. 62/976,949, filed on Feb. 14, 2020.

(51) Int. Cl. A45C 11/00; H04R 1/10; H02J 7/00; A45F 5/02; A45C 15/00

(52) U.S. Cl. CPC A45C 11/00; H04R 1/1016; H04R 1/1041; H04R 1/1025; A45F 2005/002; A45F 5/02; A45C 15/00; H04R 2420/07; H02J 7/0045

(57) ABSTRACT

Embodiments of a wireless audio earpiece holder and multi-function wearable electronic device provide for one-handed operation. The wearable electronic apparatus is attached to an operator as a pendant to a necklace, garment or both. The apparatus provides quick, safe, and convenient one-handed use to execute a variety of tasks and functions in user-safety oriented and multitasking environments. The apparatus interfaces between a wireless audio earpiece and a smartphone or wireless computing and communication device, providing one handed command capability to obviate the need to otherwise access and manipulate a smartphone or similar device.

### CROSS-REFERENCE TO RELATED APPLICATIONS

This application claims the benefit of U.S. Provisional Application No. 62/976,949 filed Feb. 14, 2020 and the entire content is incorporated by reference herein and made part of this specification.

### BACKGROUND OF THE INVENTION

### Field of the Invention (Technical Field)

The present invention is related to portable holders for wireless audio Bluetooth® earpieces and headsets. Bluetooth is a wireless technology standard used for exchanging data between fixed and mobile devices over short distances using UHF radio waves in the industrial, scientific and medical radio bands, from 2.402 GHz to 2.480 GHz, and building personal area networks.

### Background Art

Note that the following discussion may refer to a number of publications and references. Discussion of such publications herein is given for more complete background of the scientific principles and is not to be construed as an admission that such publications are prior art for patentability determination purposes.

Wireless earpieces and headsets have become extremely popular, even indispensable, to many mobile phone users. However, many users wish not to wear an earpiece constantly, for reasons of comfort, aesthetics, battery life and electromagnetic frequency (EMF) exposure. Additionally, while not worn, a wireless earpiece must be readily available to answer incoming calls quickly, so pockets, purses and containers of various design are less than optimal.

In US20090016559A1 and similar devices, two hands are required to attach and detach an earpiece to and from a holder, pendant or charging/storage container. This makes such devices difficult or impossible to use effectively in many real life circumstances, such as for users with a physical disability, when one hand is full or when a user is driving a vehicle, riding a bicycle and so on.

Wireless earpieces are easy to lose and/or damage, owing to their small size and lightweight construction. Alternative means of securing an earpiece to a holder are less than optimal. Magnetic fastening is less than ideal for this application because cannot be reliably secured without overly powerful magnets and ferromagnetic components, which would add considerable mass and bulk to a compact wearable device. Magnets as a means of secure attachment may also suffer undesirable attraction to other metal objects such as glasses frames, jewelry, clothing buttons, clasps and other wearable devices. Magnets may additionally interfere with or compromise other electronic devices such as pacemakers.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### SUMMARY OF THE INVENTION (DISCLOSURE OF THE INVENTION)

The present invention comprises an apparatus comprising a wearable electronic apparatus and wireless audio holder comprising an earpiece holder comprising a case and an attachment disposed on said holder comprising a plurality of springs disposed in a cavity wherein said springs comprise a plurality of indented springs transversely opposed and affixed to the facing sidewalls of said cavity. The earpiece holder is detachably attached to a necklace, material or clothing.

The springs form two narrow collinear gaps, between which the spring indentations form a wider collinear gap , such that the earpiece is securely and detachably attached to the holder by the opposing compressive loads of the springs acting upon the neck of the earpiece when the earpiece is positioned longitudinally between the narrow gaps and transversely between the spring indentations.

The present invention further comprises a rechargeable battery and charging circuits that recharge the rechargeable battery of a wireless audio earpiece and further comprises a plurality of electronic components that connect wirelessly with a plurality of electronic devices such as smartphones, computers and wireless earpieces.

The apparatus comprises pill storage within an onboard container, wherein the interior is accessed by a manually retractable sliding screen door, which is held closed by means of a spring return mechanism of compression or tension design.

The present invention comprises a method for attaching or detaching a wearable electronic apparatus and wireless audio holder comprising moving one hand downward to securely attach and readily detach the holder; moving the holder through the narrowest portion of the upper aperture of the springs; snapping the earpiece to a secure resting place between the spring indentations; and releasing and rapidly deploying the earpiece.

The method further comprises disposing the ignitor wires in channels through the casing;

recharging a battery and charging circuits comprising charging circuitry connecting via electrical contacts on the retainer springs and earpiece respectively and/or inductive coupling coils mounted within the main body and earpiece respectively; and relaying data between a plurality of devices in order to transfer data, connect incoming calls, initiate outgoing calls by voice command, initiate 911 calls by button command, optionally and automatically forward GPS location and medical data to 911 operator

### BRIEF DESCRIPTION OF THE DRAWINGS

The accompanying drawings, which are incorporated into and form a part of the specification, illustrate the practice of embodiments of the present invention and, together with the description, serve to explain the principles of the invention. The drawings are only for the purpose of illustrating certain embodiments of the invention and are not to be construed as limiting the invention. In the drawings FIGS. 1-7 show various views of a complex holder for wireless audio (Bluetooth®) earpieces and headsets.

FIG. 1 is an illustration of the front side view of the holder with an earpiece secured;

FIG. 2 is an illustration of illustration of the cover plate for the hardware bay of the rear side of the apparatus;

FIG. 2A is an illustration of the back side view of the apparatus of the present invention holder and a quick-release fastening mechanism;

FIG. 2B illustrates the top view of the female fastening mechanism;

FIG. 2C illustrates the bottom view of the female fastening mechanism;

FIG. 2D illustrates a side view of the male fastening mechanism;

FIG. 2E illustrates the front view of the male fastening mechanism;

FIG. 2F illustrates the bottom view of the male fastening mechanism;

FIG. 2G illustrates the top view of the male fastening mechanism;

FIG. 2H illustrates an alternate bottom view of the male fastening mechanism;

FIG. 3 is an illustration of the left side view of the apparatus of the present invention holder;

FIG. 4 is an illustration of the right side view of the apparatus of the present invention holder;

FIG. 5 is an illustration of the top side view of the apparatus of the present invention holder;

FIG. 6 is an illustration of the bottom side view of the apparatus of the present invention holder; and

FIG. 7 shows a perspective view of the apparatus of the present invention holder 100.

FIG. 8 shows a top view of an embodiment of the apparatus of the present invention; and

FIG. 9 shows an interior top view of an embodiment of the present invention.

### DETAILED DESCRIPTION OF EMBODIMENTS OF THE INVENTION

Embodiments of the present invention incorporate a novel mechanism for securely housing a wireless audio (Bluetooth®) earpiece 20 disposed in apparatus comprising holder 100. The mechanism functions to secure apparatus comprising earpiece 20 while not in use. Holder 100 is detachably secured to a necklace, chain, string or wire by disposing or lacing it through holder 100 comprising tube 36, wherein the tube is disposed in the holder, and it is additionally or distinctly detachably attached to any article of clothing by means of clip comprising clothes clip 56 affixed to rear cover plate 200 of holder 100.

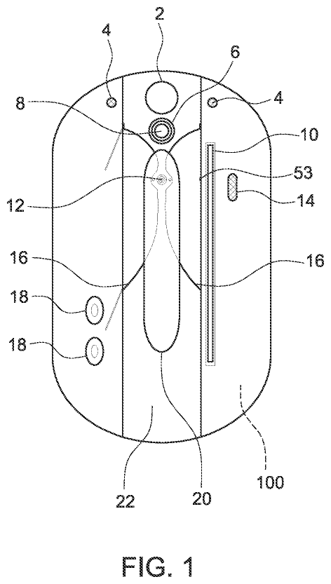

FIG. 1 is an illustration of the front side view of the holder with an earpiece secured. In FIG. 1 the holder preferably employs dual spring retainer 16 to secure earpiece 20 combined with magnet comprising alignment magnet 6, enabling speedy one-handed detachment of the earpiece from the holder in order to quickly and reliably answer incoming calls, then enabling one-handed re-attachment of earpiece 20 to holder 100 once a call has ended.

The method of use of the preferred embodiment of the present invention comprises the following steps.

Dual spring retainer 16 provides for earpiece 20 to be securely attached to and detached from holder 100 using only one hand by means of a downward motion when holder 100 is held steady under tension, for example when it is securely attached to clothing, or when the necklace it is attached to is under tension.

Indentations are disposed in springs 16 for receiving the cylindrical portion (the neck) of earpiece 20 that connects the earplug to the rest of the apparatus of the present invention. The portion of the earpiece comprising a cylindrical portion or neck is preferably inserted from the top, providing tension to the necklace holder 100 is attached to (or to the clothing or other material to which the holder is affixed) until it snaps into the indentations. A majority of earpieces on the market have a similar or standard diameter neck size, and dual spring 16 comprising the design of this device allows for some deviation from this standard while still providing adequately secure storage of the earpiece. The design of holder 100 also allows for replacement of pairs of spring 16 of different sizes, configurations, designs, and forms, in order to accommodate earpieces 20 with necks of any diameter.

Springs 16 comprising a pair of springs, are preferably mounted transversely opposed to one another within half-pipe channel shaped cavity 22 which is disposed along the full length of the longitudinal centerline of holder 100. Cavity 22 allows easy manual access and manipulation of earpiece 20 while attaching or detaching an earpiece. Springs 16 are attached to the walls of channel 22 by inserting the spring legs into tight tolerance indentations comprising slits 52 which receive spring 16 extensions. Indentations comprising slits 52 provide a friction-fit fixed mounting position because spring 16 extensions terminate at an end of each slit 52. In use, the unidirectional process of attaching and detaching an earpiece loads springs 16 with varying degrees of compression while earpiece 20 is being subsequently attached, stored and detached.

Springs 16 are maximally compressed and maximally impinging upon the earpiece 20 neck as earpiece 20 is pulled downward through the narrowest portion of the upper spring gap. Once earpiece 20 is pulled past this narrow gap, the neck of earpiece 20 snaps into place and is therefore securely held between spring 16 indentations, where springs 16 are moderately compressed and moderately impinging upon earpiece 20 neck. When earpiece 20 is pulled further downward through the lower gap between springs 16, springs 16 are again maximally compressed and maximally impinging upon earpiece 20 neck. The two previously mentioned narrow gaps between springs 16 thus act as a pair of gates which secure earpiece 20 by restraining motion along the length of holder 100, while opposing spring 16 loads secure holder 100 by restricting lateral movement. Earpiece 20 is restrained from vertical movement or escape due to earpiece 20 design where the neck diameter is sufficiently less than the width of the main body of earpiece 20 above and less than the diameter of the speaker assembly of earpiece 20 below. Therefore the neck of the earpiece is secured along the vertical axis due to the narrow aperture of springs 16 preventing earpiece 20 main body or speaker assembly from moving upward or downward with respect to springs 16 as they impinge upon the neck of earpiece 20.

More steps comprising the method of use of the present invention follow.

Earpiece 20 is detached from holder 100 by exerting force on earpiece 20 to dispose it further downward, again providing tension to the necklace holder 100 is attached to (or the article of clothing or material to which holder 100 is affixed), eventually moving spring 16 indentations and freeing the earpiece. Thus only one, not both, of the user's hands is required to insert and remove earpiece 20 from holder 100.

An additional embodiment of the apparatus of the present invention comprises optional magnet 6 comprising a ring magnet that when the magnet is disposed adjacent to, preferably encircling, light emitting diode (LED) light 8 provides for alignment of earpiece 20 with the upper aperture of springs 16 before attaching earpiece 20 to holder 100. The speaker element of earpiece 20 is connected to magnet 6 which is disposed adjacent to, preferably above, i.e. at one end of, spring 16 aperture along the center line of holder 100. Then user disposes the apparatus of the present invention downward or away from the upward end. The method of use comprising the process of attaching earpiece 20 is intuitive, obviating the need for user visual verification. These design features enable the ease of one-handed attachment and detachment of earpiece 20 in many multitasking or safety priority circumstances, for example, while driving.

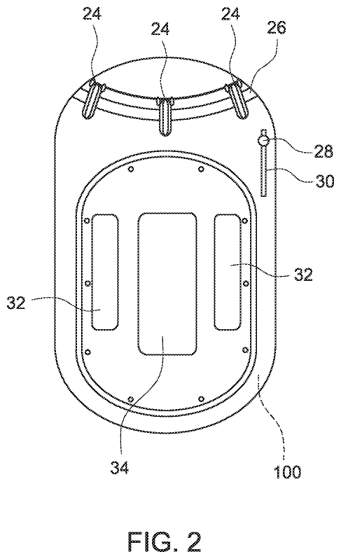

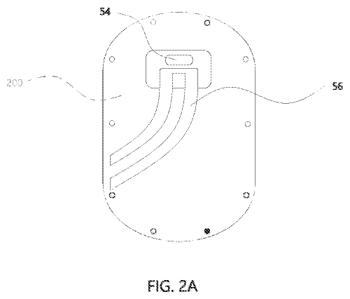

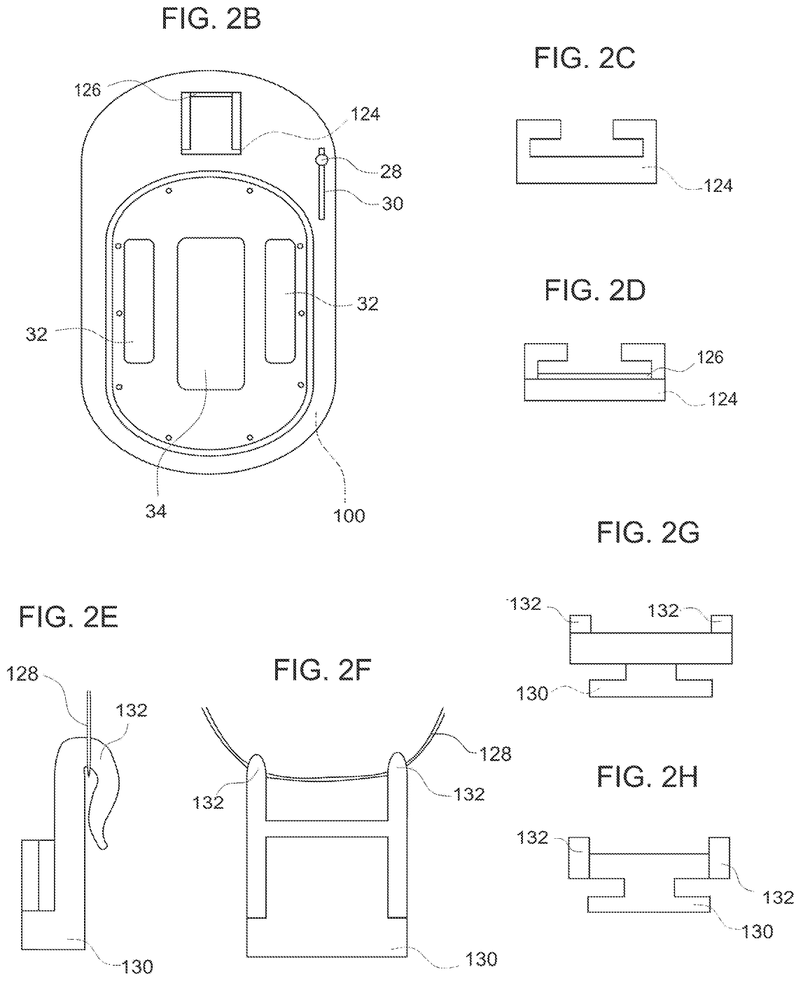

An alternate embodiment of the present invention comprises the following. FIG. 2A illustrates the back view of holder 100 with the front view of female fastener 124, which comprises one part of a two piece alternative quick release fastening mechanism. FIG. 2B shows the top view of female fastener 124. FIG. 2C shows the bottom view of female fastener 124. FIG. 2D shows a side view of male fastener 130 portion of the fastening mechanism. FIG. 2E shows the front view of male fastener 130. FIG. 2F shows the bottom view of male fastener 130. FIG. 2G shows the top view of male fastener 130. FIG. 2H illustrates an alternate bottom view of the male fastening mechanism.

FIGS. 2A-F illustrate an alternative embodiment of the present invention comprising a quick release fastening mechanism, which comprises t-shaped male fastener 130 to be disposed on to necklace 128, and t-shaped (cavity) female fastener 124 disposed adjacent to, preferably attached to, a side, preferably the back side of holder 100, such that holder 100 is moved, preferably pulled in a downward direction—with both fasteners aligned—wherein male fastener 130 is inserted, pulling until the male fastener terminates at end-stop 126 of female fastener 124.

The method of use of the present embodiment of the present invention comprises the following steps. The male fastener is affixed to necklace 128 or garment feature by pulling a necklace through the narrow aperture of clasps 132 of male fastener 130 until necklace 128 is fully seated. The necklace passes through the two cavities of sprung clasps 132, once necklace 128 is fully seated upon male fastener 130, wherein these cavities are of larger diameter than the aperture of the narrowest gap of clasps 132, thus a variety of necklace 128 diameters is accommodated. Fastener 130 is secured when used by the spring tension of clasps 132, which impinge upon the surface of necklace 128 or garment or material feature in order to resist accidental detachment of male fastener 130 from necklace 128 or the garment feature or material.

Male 130 and female 124 fasteners are preferably friction fit and comprised of durable material such as metal or hard plastic, so holder 100 is secure while being worn. This fastening mechanism is advantageous due to the fact that the most forceful tactile manipulation of holder 100 during typical use comprises attaching and detaching earpiece 20, wherein both actions are performed under tension with respect to holder 100, necklace 128 or any suitable garment feature. Holder 100 is securely affixed to necklace 128 during normal use until holder 100 is detached from necklace 128, wherein one operator hand holds the male fastener from its back side while the other operator hand pulls the holder 100 preferably upward. The male fastener remains affixed to the necklace 128 or garment feature, such as a lapel or pocket when detached. Thus using this method holder 100 is easily and securely attached to and detached from necklace 128 or any garment to which male fastener 130 is affixed.

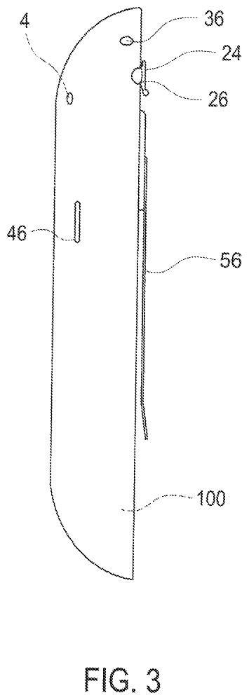

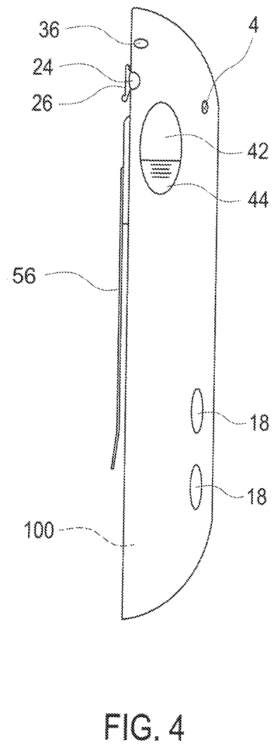

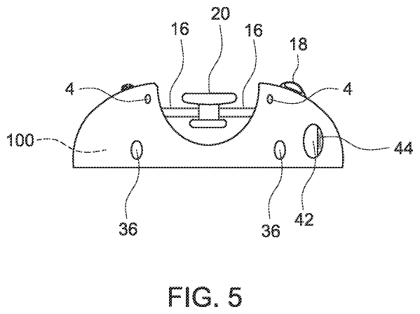

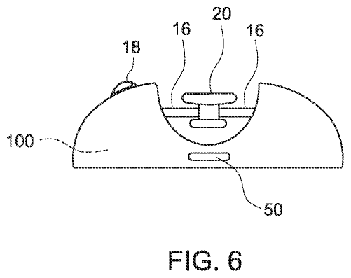

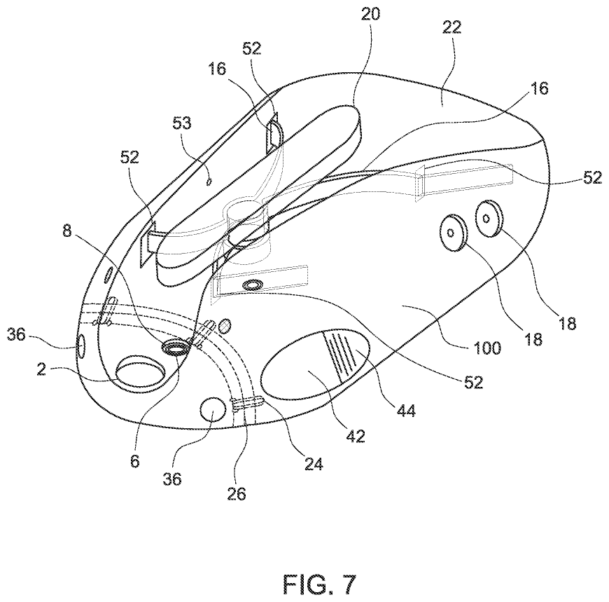

FIG. 3 is an illustration of the left side view of the apparatus of the present invention holder. FIG. 4 is an illustration of the right side view of the apparatus of the present invention holder. FIG. 5 is an illustration of the top side view of the apparatus of the present invention holder. FIG. 2A is an illustration of the rear cover plate of the apparatus of the present invention holder.

The holder is semi-permanently disposed on a necklace by disposing, comprising lacing, a necklace through tube 36 as illustrated in FIGS. 3, 4, and 5. The tube is disposed through the main body of holder 100. Alternatively holder 100 is quickly attached to and released from a necklace by means of pulling a necklace through the 3 spring loaded clasps 24 as illustrated in FIG. 2A so that the necklace is disposed in or seats in channel 26 comprising curved half pipe channel on a side comprising the back surface of holder 100.

Fasteners comprising clasps 24 are spring loaded to remain closed and retain a necklace in place until removal is desired. Clasps 24 have protruding elements comprising protruding lips which provide for a necklace to be pulled under tension into the channel where the necklace is secured and fully seated. A preferred method of use comprises removing a necklace, where holder 100 is inverted vertically, and the necklace is pulled with tension in a downward direction to overcome the spring tension of clasps 24.

In addition to the previously described spring 16 retainer design, an alternate embodiment of the present invention holder 100 also provides a number of components providing functionality typical to many smart devices such as smart phones and watches, but in an ergonomically advantageous and superior design. Holder 100 provides components including yet not limited to: digital camera 2; audio speakers 14; microphones 4; LED flashlight and notification indicator 8; radio antennae 10; dual multi-touch control buttons 18; notification vibrator motor; global positioning system (GPS) transceiver; near field communication (NFC) transceiver; wireless or Bluetooth® transceiver; rechargeable batteries 32; wired charging circuitry; inductive charging circuitry 12; application specific integrated circuits (ASICs) and microcontrollers 34; solid state drive (SSD) memory on chip 34; enclosed pill container 42 with retractable door 44; spring-release necklace clasp 24; flat spring clothes clip 56; and/or quick response (QR) scannable medical identification tag 54. Wired and Inductive charging circuitry may be used to recharge batteries for both the holder and a corresponding earpiece.

The functionalities represented by these components are enhanced by the placement of the holder 100 on a necklace or on clothing, as compared with a smart phone typically stored in a pocket, holster, purse or bag. Time is often of the essence when it is desired to capture a spontaneous audio, photo and video recording. Additionally, speaker 14 and microphone 4 placement on holder 100, worn as a pendant on a necklace or on clothing provides optimal acoustics for speakerphone capability with more than one speaker in close proximity. The operator's hands-free LED flashlight 8 capability is ideally situated for many tasks; for example finding a dropped item or locating a keyhole at night.

The operator's clothes clip provides additional stabilization in many circumstances by providing for holder 100 to be restrained both by the tensioning of the necklace and disposal of the holder's clothes clip 56 upon a garment feature such as a lapel, placket, pocket, collar, or cuff. Holder 100 conveniently replaces or augments many common user input/output (I/O) commands that would otherwise require physically accessing a smartphone or other computer device similar to a smart watch yet to a greater extent.

Multicolor LED flashlight/notification light 8 provides for notifications from a smartphone or similar device to be pushed to the holder, indicating new messages (email, short message service (SMS), voice over internet (VOIP)) originating from and/or relayed from a smartphone or wireless computer device. Software programmable or automatically rendered color coding and pulsing of light from LED 8 provides for the user to discern which type and number of messages which are recently received without accessing the smartphone or similar device. The operation of flashlight 8 has a software programmable or default timer to automatically disable LED 8 after a specified number of seconds.

Audio speaker 14 and a pair of noise canceling stereo microphones 4 provide for the holder to provide audio input and output for the purpose of conducting, recording, and playback of speakerphone voice calls and audio recordings.

A vibrating notification motor allows near silent notification of incoming calls or messages.

A proximity sensor and associated circuitry on the holder (and/or the earpiece) provides for automatic powering on/off of the earpiece when attached to or detached from the holder. This provides for a complementary earpiece to be designed without any onboard buttons or actuators, thus reducing size and weight, as typically considered desirable for wearable electronics. For example, releasing the earpiece from the holder commands the proximity sensing circuit to signal earpiece 20 to automatically power on in order to receive a call. The proximity sensing circuit automatically commands the earpiece to power off, and additionally instructs holder 100 to resume inductive charging of the earpiece battery as necessary when the earpiece is reattached to the holder. Earpiece 20 volume is controlled by holder's 100 controls comprising buttons 18.

The method of use of this embodiment of the present invention comprises the following. Two multi-touch control buttons 18 provide for the user to operate all features of the apparatus and a complementary earpiece. Discrete key commands instruct outputs as follows: button 1 short press: answer/end call with speakerphone; button 1 long press: record/end record audio; button 1 double press: turn on/off flashlight; button 2 short press: take photo; button 2 long press: record/end record video; button 2 double press: toggle sound/vibrate notification; button 1&2 short press: activate cigarette arc lighter; and/or button 1&2 long press: 911 auto-dial call.

Radio antennae 10 disposed adjacent to or preferably in the chassis of holder 100 provides for transmission and relay of wireless signals between an earpiece and a smartphone or wireless computer device.

Scannable medical identification tag 54 disposed on the holder's cover plate provides for rapid scanning of user medical data.

Holder 100 recharges earpiece 20 via inductive coupling charging circuit 12, wherein holder 100 charging coil 12 is disposed adjacent to, preferably located directly beneath, speaker of earpiece 20 while earpiece 20 is attached to the holder. Thus, earpiece 20 of specific design, having its inductive coupling receiver coil disposed adjacent to, preferably mounted within, the earpiece's speaker assembly providing for charging of battery of earpiece 20.

Holder 100 provides universal serial bus (micro-USB or USB-C) data/charging port 50 to transfer data and charge the batteries of holder 100. Holder 100 contains one or more ASICs or purpose-built microcontrollers 34 which provide for input of commands to control button 18 to activate and deactivate functions including but not limited to: activate and deactivate camera 2; activate and deactivate LED light 8; activate and deactivate audio microphones 4; play and record audio; activate/deactivate speaker 14; initiate data transfer; turn earpiece 20 on/off; answer calls; automatically dial calls via voice dialing; automatically dial 911 or a preprogrammed emergency contact. Onboard SSD memory 34 provides for holder 100 to store data, including but not limited to photo image files, video and audio recording files, and phone numbers.

The holder contains Bluetooth®, GPS and near field communication (NFC) transceivers that provide for transmission of data and location to a smartphone or wireless electronic computer device. Holder 100 provides for executing contactless payment and programmable encrypted keyless entry, among other tasks which typically require manipulating a smartphone, key card or free on board (FOB).

Digital camera 2 is disposed on holder 100 for recording photographic images and video. A clip comprising j-shaped sprung clothes clip 56 is disposed on a cover plate of the holder, preferably on rear plate 200 which provides for holder 100 to be detachably disposed adjacent to, preferably attached to any article of clothing at a location comprising a vertical or horizontal edge, such as a lapel, placket, pocket, collar, or cuff.

An alternate embodiment of the present invention comprises pill container 42 disposed adjacent to the holder for fast and accessible storage of emergency medication or daily doses. Medication or pill container 42 forms a cavity in the body of the holder and spring loaded retractable sliding door 44 secures the content medication. Tactile ridges on the exterior surface of the sliding door facilitate sliding of the retractable door to access contents.

Yet another embodiment of the present invention comprises the following. A vibrating motor provides for holder 100 to relay new notifications to an operator. Pulsed vibration patterns are assigned to various types of communications with each pulse lasting a fraction of a second with the notifications originating from a smartphone or wireless computer device. Types of pulses and examples of their communication type include: single short pulse: new SMS; single long pulse: new email account #1; double short pulse: new VOIP messenger communication; double long pulse: new email account #2; triple short pulse: new voicemail; triple long pulse: new emergency broadcast (cellular network provider).

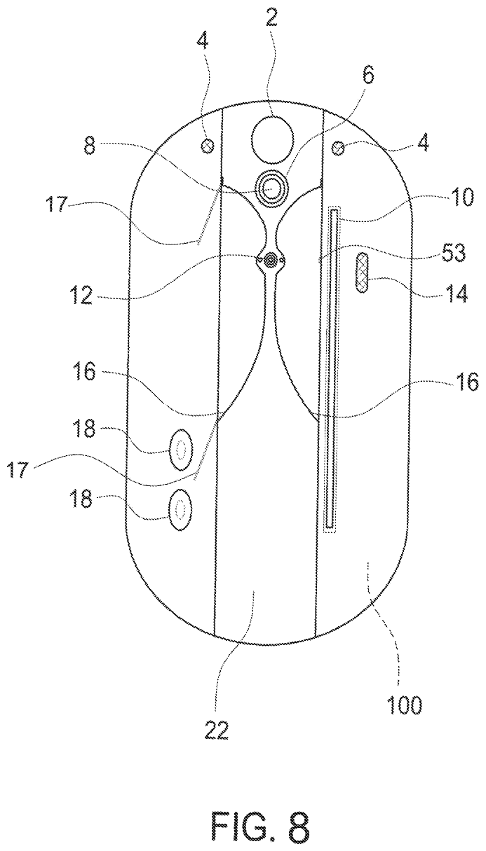

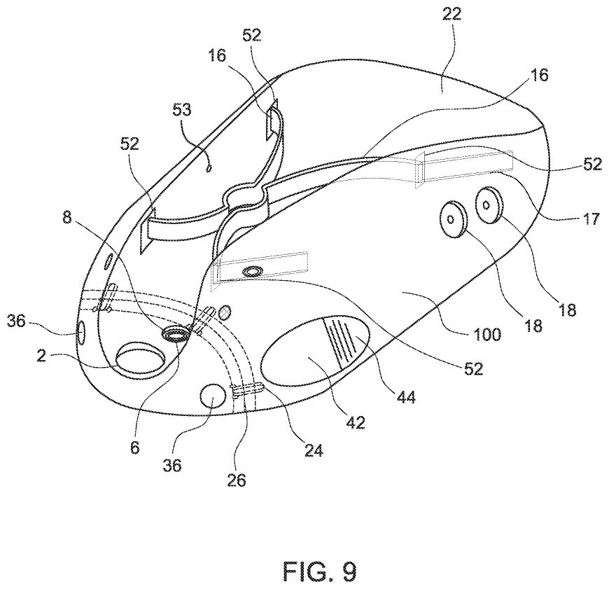

FIG. 8 shows a top view of an embodiment of the apparatus of the present invention. FIG. 9 shows an interior top view of an embodiment of the present invention.

Note that in the specification and claims, “about” or “approximately” means within twenty percent (20%) of the numerical amount cited. As used herein, the singular forms “a,” “an,” and “the” include plural referents unless the context clearly dictates otherwise. Thus, for example, reference to “a functional group” refers to one or more functional groups, and reference to “the method” includes reference to equivalent steps and methods that would be understood and appreciated by those skilled in the art, and so forth.

Although the invention has been described in detail with particular reference to the disclosed embodiments, other embodiments can achieve the same results. Variations and modifications of the present invention will be obvious to those skilled in the art and it is intended to cover all such modifications and equivalents. The entire disclosures of all patents and publications cited above are hereby incorporated by reference.

What is claimed is:

1. An apparatus comprising a wearable electronic apparatus and wireless audio holder comprising:
an earpiece holder comprising a case; and
an attachment disposed on said holder comprising a plurality of springs disposed in a cavity.

2. The apparatus of claim 1 wherein said springs comprise a plurality of indented springs transversely opposed and affixed to the facing sidewalls of said cavity.

3. The earpiece holder of claim 1 wherein said holder is detachably attached to a necklace, material or clothing.

4. The apparatus of claim 1 wherein said springs of claim 1 form two narrow collinear gaps, between which the spring indentations form a wider collinear gap , such that the earpiece is securely and detachably attached to the holder by the opposing compressive loads of the springs acting upon the neck of the earpiece when the earpiece is positioned longitudinally between the narrow gaps and transversely between the spring indentations.

5. The apparatus of claim 1, further comprising a rechargeable battery and charging circuits that recharge the rechargeable battery of a wireless audio earpiece.

6. The apparatus of claim 1 comprising a wearable electronic device further comprising a plurality of electronic components that connect wirelessly with a plurality of electronic devices such as smartphones, computers and wireless earpieces

7. The apparatus of claim 1 comprising pill storage within an onboard container, wherein the interior is accessed by a manually retractable sliding screen door, which is held closed by means of a spring return mechanism of compression or tension design.

8. A method for attaching or detaching a wearable electronic apparatus and wireless audio holder comprising:
moving one hand downward to securely attach and readily detach the holder;
moving the holder through the narrowest portion of the upper aperture of the springs;
snapping the earpiece to a secure resting place between the spring indentations; and
releasing and rapidly deploying the earpiece.

9. The method of claim 8 further comprising disposing the ignitor wires in channels through the casing.

10. A method of recharging a battery and charging circuits comprising charging circuitry connecting via electrical contacts on the retainer springs and earpiece respectively and/or inductive coupling coils mounted within the main body and earpiece respectively.

11. The method of claim 10 comprising relaying data between a plurality of devices in order to transfer data, connect incoming calls, initiate outgoing calls by voice command, initiate 911 calls by button command, optionally and automatically forward GPS location and medical data to 911 operator
